(19) United States
(12) Patent Application Publication
(10) Pub. No.: US 2026/0044872 A1
(43) Pub. Date: Feb. 12, 2026

(54) METHOD FOR REDUCTION OF FUEL CONSUMPTION OF A VEHICLE

(71) Applicant: IVECO S.P.A., TORINO (IT)

(72) Inventors: Valerio Liga, TORINO (IT); Fabrizio Conicella, TORINO (IT)

(73) Assignee: IVECO S.P.A., TORINO (IT)

(21) Appl. No.: 19/103,018

(22) PCT Filed: Aug. 16, 2023
(86) PCT No.: PCT/IB2023/058215

§ 371 Date: Feb. 11, 2025

(30) Foreign Application Priority Data
Aug. 24, 2022 (IT) 102022000017538

(51) Int. Cl. G06Q 30/0207; G06Q 20/36

(52) U.S. Cl. CPC G06Q 30/0215; G06Q 20/36; G06Q 2220/00

(57) ABSTRACT

Method for reduction of fuel consumption of a vehicle operable by a driver, the method being executed by processing means and comprising: acquiring driving data indicative of the functioning of the vehicle determining, based on the driving data, a driving score indicative of a degree of fuel consumption for operating the vehicle by the driver; associating to the driving score a respective token number indicative of an amount of tokens that depends on said degree of fuel consumption of the vehicle and assigning through blockchain, the amount of tokens to one or more target wallets, the one or more target wallets being a driver wallet of the driver and/or a fleet owner wallet of a vehicle fleet owner owning the vehicle.

### CROSS-REFERENCE TO RELATED APPLICATIONS

This Patent Application claims priority from Italian Patent Application No. 102022000017538 filed on Aug. 24, 2022, the entire disclosure of which is incorporated herein by reference.

### TECHNICAL FIELD

The present invention concerns a method for reduction of fuel consumption of a vehicle. It also relates to said vehicle, to a system comprising said vehicle and to a computer program product thereof.

The present invention finds its preferred, although not exclusive nor limiting, application in work vehicles or heavy vehicles, preferably in a fleet of vehicles (e.g., in a fleet of trucks).

### BACKGROUND OF THE INVENTION

Modern vehicles are often driven and controlled by the driver so as to maximize their performances, such as in order to maximize their travelling speed or minimize the time required to perform a certain manoeuvre (e.g., lifting a weight by a heavy vehicle such as a wheel loader).

Nevertheless, this general behaviour in controlling and driving the vehicles causes them to often work in high performance mode (e.g., by travelling at high speed or generating high hydraulic pressures in a hydraulic system of the vehicle), thus requiring high fuel consumption.

Since the fuel economy and the vehicle performances are generally in trade-off between them, several solutions are known to optimize one of them, at the expense of the other. Other known solutions allow the driver to choose the desired trade-off level among several possibilities (e.g., the driver can select the most appropriate option of fuel consumption and vehicle performance based on the task to be executed).

These solutions have been demonstrated to effectively reduce the fuel consumption of vehicles.

Nevertheless, it has been verified that often the driver does not fully comply with the requirements and optimal working ranges of the selected trade-off level and for example forces the vehicle to work at higher performances than those optimal for the selected trade-off level (e.g., forces the vehicle to travel at a speed that is higher than the one predefined for the option of fuel consumption and vehicle performance that has been selected).

This lack of compliance of the driver with the optimal working ranges of the selected driving mode causes additional fuel consumption that should be avoided.

Therefore, the need is felt to provide a solution that pushes the driver to comply with the optimal driving mode and, more in general, that allows to reduce the vehicle fuel consumption.

### SUMMARY OF THE INVENTION

An aim of the present invention is to satisfy the above-mentioned needs.

The aforementioned aim is reached by a method for reduction of fuel consumption of a vehicle, a vehicle, a system comprising said vehicle and a computer program product, as claimed in the appended set of claims.

### BRIEF DESCRIPTION OF DRAWINGS

For a better understanding of the present invention, a preferred embodiment is described in the following, by way of a non-limiting example, with reference to the attached drawings wherein:

FIG. 1 is a block diagram schematically illustrating a vehicle, according to an embodiment of the present invention;

FIG. 2 is a block diagram schematically illustrating a method for reduction of fuel consumption when driving the vehicle of FIG. 1, according to an embodiment of the present invention;

FIG. 3 is a block diagram schematically illustrating a system comprising a fleet of the vehicles of FIG. 1, according to an embodiment of the present invention.

### DETAILED DESCRIPTION OF THE INVENTION

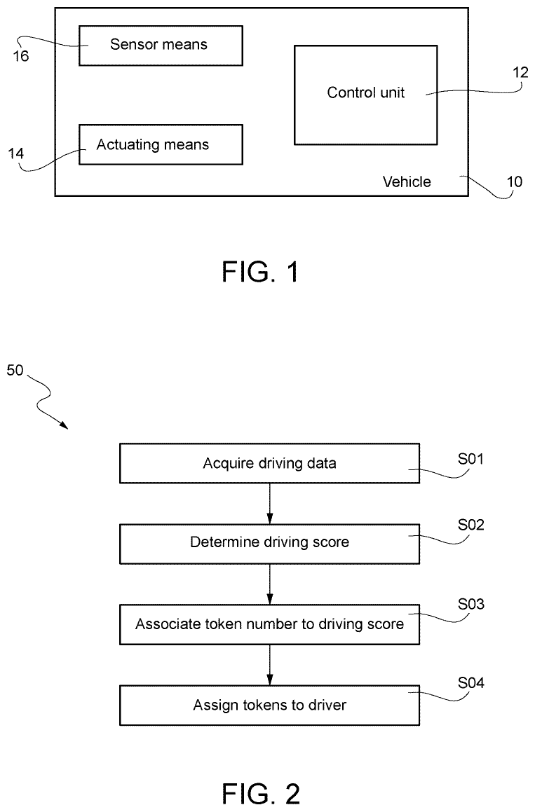

FIG. 1 shows a vehicle 10. In particular, the vehicle 10 is a heavy vehicle (e.g., a truck) or a work vehicle (e.g., a tractor or a wheel loader).

The vehicle 10 comprises a control unit 12 configured to control the vehicle 10. For example, the control unit 12 is a vehicle control unit, VCU, of per se known type.

For example, the control unit 12 can comprise a communication module (not shown and of a per se known type, such as transceiver module able to communicate through RF or wireless technology) for transmitting and receiving data outside the vehicle 10, as better discussed in the following.

In particular and in a per se known way, in use the control unit 12 generates one or more vehicle control signals that control the functioning of the vehicle 10 and, more in details, that control one or more driving conditions of the vehicle 10 (e.g., travelling speed, positioning of a telescopic arm of the vehicle 10, air conditioning level, etc.).

For example, the control unit 12 is operatively coupled to actuating means 14 of the vehicle 10 that, during use, receive the vehicle control signals from the control unit 12 and control the vehicle 10 accordingly.

The vehicle 10 further comprises sensor means 16 that are operatively coupled with the control unit 12 and are configured to acquire driving data of the vehicle 10. In particular, the driving data are indicative of the functioning of the vehicle 10 and, for example, of the one or more driving conditions of the vehicle 10. As illustrative and non-limiting examples, the driving data comprise at least one among the measured travelling speed of the vehicle 10, the measured position of the telescopic arm of the vehicle 10, the temperature in a cabin of the vehicle 10, the position of the steering wheel, etc.

According to an embodiment of the present invention, the control unit 12 implements a method 50 for reduction of fuel consumption.

FIG. 2 shows the method 50.

At a step S01 of the method 50, the control unit 12 acquires the driving data of the vehicle 10 through the sensor means 16.

At a step S02 of the method 50, consecutive to step S01, the control unit 12 determines a driving score based on the driving data. In particular, the driving score is indicative of the driver's quality of driving the vehicle 10 and, more in details, is indicative of the degree of fuel consumption of the vehicle 10. In other words, the driving score is indicative of the correlation between the driver's driving behaviour and the vehicle fuel consumption.

For example, the driving score is inversely proportional to the degree of fuel consumption and thus increases as the fuel consumption required to drive the vehicle 10 reduces and decreases as the fuel consumption increases. Therefore, the driving score increases if the driver has a driving behaviour that reduces the fuel consumption of the vehicle 10. In particular, the driving score can vary between a minimum driving score (e.g., 0) and a maximum driving score (e.g., 100), wherein the minimum driving score corresponds to the highest degree of fuel consumption when driving the vehicle 10 and the maximum driving score corresponds to the lowest degree of fuel consumption when driving the vehicle 10.

In further details, the driving score is calculated according to per se known criteria and techniques used in currently available systems such as the Driver Evaluation System (DES), the Driving Style Evaluation (DSE) or the Driving Attention Support (DAS) system. For example, the DAS system evaluates the attention and driving style of the driver by analysing data such as movements of the steering wheel, voluntary and involuntary movements of the driver, working parameters of the vehicle 10; this also allows to detect drowsy driving and to provide an alert to the driver if required.

In further details, the driving score is determined by comparing the driving data with predetermined ranges of driving data (e.g., by comparing the measured travelling speed of the vehicles with one or more predefined travelling speed thresholds).

At a step S03 of the method 50, consecutive to step S02, the control unit 12 associates a token number to the driving score.

The token number is indicative of the driving score (e.g., is directly proportional to it) and thus is indicative of the degree of fuel consumption of the vehicle 10. Therefore, the token number increases if the driver has a driving behaviour that reduces the fuel consumption of the vehicle 10, and decreases otherwise. In particular, the token number can vary between a minimum token number (e.g., 0) and a maximum token number (e.g., 1000), wherein the minimum token number corresponds to the minimum score number and thus to the highest degree of fuel consumption when driving the vehicle 10 and the maximum token number corresponds to the maximum driving score and thus to the lowest degree of fuel consumption when driving the vehicle 10.

For example, the token number is determined, based on the driving score, by means of a look-up table associating to each driving score a respective token number (alternatively, associating to each range of driving scores a respective range of token numbers).

The token number is a number of tokens that are managed (e.g., exchanged) through blockchain.

As commonly known, the blockchain is a shared, programmable and immutable data structure formed by a growing list of records, called blocks, which are securely concatenated together using cryptography. The blocks are indicative of respective actions concerning token manipulation (e.g., generation and transfer), that are managed through respective smart contracts stored in the blocks.

In details, each block comprises a cryptographic hash of the previous block, a timestamp, and transaction data of the respective smart contract. The timestamp proves that the transaction data existed when the block was published to get into its hash. Since each block comprises information about the previous block, they form a chain wherein each additional block reinforces the security and immutability of the ones before it. Therefore, the blockchain is resistant to modification of its data because once recorded, the data in any given block cannot be altered retroactively without altering all subsequent blocks.

The tokens are digital assets defined by the smart contract and managed (e.g., trasferred) by the blockchain.

The smart contracts are digital contracts stored on the blockchain. They are automatically executed when predetermined terms and conditions are met. They are typically used to automate the execution of an agreement so that all participants can be immediately certain of the outcome, without any intermediary's involvement or time loss. They can also automate a workflow, such as triggering a next action when the conditions are met.

In the present case, the blockchain is of per se known type (for example, Ethereum) and is not further described in details here.

For example, the blockchain is owned and managed by the vehicle producer.

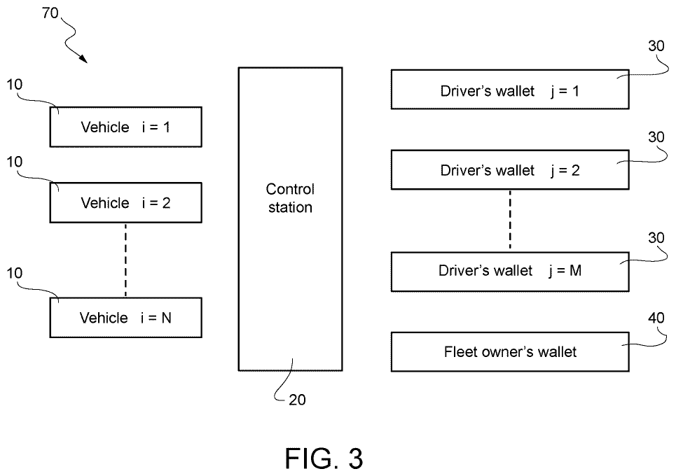

For example, the blockchain is stored in an external unit (e.g., the control station 20 of FIG. 3) that is external to the vehicle 10 and that can be owned by the vehicle producer. The control unit 12 is operatively couplable, for example through the communication module, to the external unit in order to access the blockchain and add new blocks. Alternatively, the blockchain is on cloud and the control unit 12 can access it, for example through the communication module.

At a step S04 of the method 50, consecutive to step S03, the control unit 12 assigns, through the blockchain, the number of tokens determined at step S03 to one or more target wallets.

The wallet is a device or program that stores cryptocurrency keys and allows to access the coins. Wallets comprise a public key (the wallet address) and a private key needed to sign cryptocurrency transactions. Anyone who knows the private key can control the coins associated with the wallet address.

In further details, the control unit 12 communicates with the blockchain and adds a new block in the blockchain. This block comprises a smart contract transferring an amount of tokens (i.e., said number of tokens) from a token source to the wallet address of a target entity (alternatively, to the wallet addresses of the target entities, in case of a plurality of target wallets).

In details, the token source is the wallet of the producer of the vehicle 10 and the one or more target entities are the driver of the vehicle 10 and/or a vehicle fleet owner.

In particular, FIG. 3 shows a system 70 comprising a fleet of N vehicles 10 owned by a vehicle fleet owner. The N vehicles 10 can be driven by M drivers (with N greater than, lower than or equal to M and, for example, N=M). A respective driver's wallet 30 is associated to, and owned by, each driver, and a fleet owner's wallet 40 is associated to, and owned by, the vehicle fleet owner. The wallets 30 and 40 are also comprised in the system 70. Moreover, the system 70 can also comprise a control station 20 (e.g., a server) owned by the vehicle producer and operatively coupled to the vehicles 10 and the wallets 30, 40.

According to an embodiment, the control unit 12 manages through the blockchain the transferral of all the tokens to the driver's wallet 30 (i.e., the token number is transferred to the driver at 100%).

According to a different embodiment, the control unit 12 manages through the blockchain the transferral of all the tokens to the fleet owner's wallet 40 (i.e., the token number is transferred to the vehicle fleet owner at 100%).

According to a further embodiment, the control unit 12 manages through the blockchain the transferral of the tokens partially to the driver's wallet 30 and partially to the fleet owner's wallet 40 (i.e., the token number is transferred in part to the vehicle fleet owner and in part to the driver). In details, the tokens are transferred to the driver's wallet 30 and to the fleet owner's wallet 40 according to predefined repartition criteria, e.g. 50% to the driver's wallet 30 and 50% to the fleet owner's wallet 40. For example, if at step S03 the token number that has been determined is equal to 700, the driver's wallet 30 can receive 350 tokens and the fleet owner's wallet 40 can receive 350 tokens.

The tokens in the wallets 30, 40 can be used, respectively by the driver and by the vehicle fleet owner, to obtain rewards from the vehicle producer. This works as an incentive for the driver to drive in a more sustainable way, i.e. reducing the fuel consumption when driving the vehicle 10.

The tokens in the wallets 30, 40 can be used by the driver or vehicle fleet owner to obtain from the vehicle producer at least one of the following: one or more gadgets (e.g., T-shirts, backpacks, etc.) ; a discount on the purchase of one more new vehicles; a discount on one or more services related to the vehicle 10; and one or more additional services related to the vehicle 10. For example, the discounts and amount of available services can increase as the amount of tokens in the target wallet increases.

These rewards can be provided by the vehicle producer for free (e.g., concerning the discounts on new vehicles or the discounts or availability of new services, for example automatically granted upon exceeding, by the target wallet, a token amount threshold) or upon token payment (e.g., the gadgets that can be bought from the vehicle producer by means of the tokens previously charged in the target wallet in response to the driver's driving behaviour).

Therefore, in case token payment is required to obtain the reward, the method 50 can additionally comprise a further step, consecutive to S04 and not shown in FIG. 2, in which the vehicle producer receives, through the blockchain and from the target wallet (upon consensus of the target entity), a predetermined token quantity that corresponds to the payment for the reward to be provided to the target entity. Upon receipt of the predetermined token quantity, the vehicle producer provides the respective reward to the target entity (e.g., sends the gadget to the driver). This additional step is implemented as previously discussed for step S04, i.e. by adding to the blockchain a new block comprising the smart contract registering the token transfer from the target wallet to the wallet of the vehicle producer (also called vehicle producer's wallet).

The method 50 can be executed iteratively.

For example, the method 50 can be iterated periodically (i.e., upon elapsing of a predetermined time interval from the last iteration of the method 50, such as each few milliseconds or few minutes or each day at a predefined hour) or upon the end of each driving session (e.g., each time the vehicle 10 is turned off). Moreover, the driving data acquisition at step S01 can be executed in real time (e.g., each millisecond) and the other steps of the method can be executed periodically or upon the end of each driving session, based on the driving data acquired from their last iteration (e.g., based on statistical elaboration of these driving data). Furthermore, the additional step can be executed upon request of the target entity (e.g., each few weeks or months, when the target wallet comprises a sufficient amount of tokens to pay the reward).

In view of the foregoing, the advantages of the method for reduction of fuel consumption of the vehicle according to the invention are apparent.

The method 50 allows to implement an incentives program that pushes the drivers and/or the fleet owner (which in turn may directly push the drivers, for example through an analogous system of rewards) to drive or to operate the vehicles 10 in the most possible sustainable way, considering all the functionalities available at vehicle level. This is achieved by using the blockchain that allows to provide rewards and/or discounts.

Therefore, the method 50 allows to improve the fuel efficiency and reduce the overall fuel consumption.

Moreover, the blockchain ensures that the token transactions are certified and cannot be altered, providing an increased reliability to the method 50.

It is clear that modifications can be made to the described method for reduction of fuel consumption of the vehicle, vehicle, system comprising said vehicle, and computer program product, which do not extend beyond the scope of protection defined by the claims.

For example, the previously described embodiments can be combined together to obtain additional solutions.

Moreover, the steps S02, S03 and S04 (as well as the additional step, if present) can be executed by the control station 20 owned by the producer of the vehicle 10. Therefore, more in general, the method 50 is executed by processing means that comprise the control unit 12 of the vehicle 10 and that can also comprise the control station 20 of the vehicle producer; the step S01 is executed by the control unit 12 and the steps S02, S03 and S04 (as well as the additional step, if present) can be executed either by the control unit 12 or by the control station 20 of the vehicle producer (or some of them by the control unit 12 and the others by the control station 20 of the vehicle producer).

Moreover, the step S03 can also be executed through the blockchain, i.e. by adding to the blockchain a block comprising a smart contract that controls the association between the driving score and the token number (analogous to what previously described).

1. Method (50) for reduction of fuel consumption of a vehicle (10) operable by a driver,
the method being executed by processing means (12, 20) and comprising:
acquiring (S01) driving data indicative of the functioning of the vehicle (10);
determining (S02), based on the driving data, a driving score indicative of a degree of fuel consumption for operating the vehicle (10) by the driver;
associating (S03)to the driving score a respective token number indicative of an amount of tokens that depends on said degree of fuel consumption of the vehicle (10); and
assigning (S04), through blockchain, the amount of tokens to one or more target wallets (30, 40), the one or more target wallets (30, 40) being a driver's wallet (30) of the driver and/or a fleet owner's wallet (40) of a vehicle fleet owner owning the vehicle (10).

2. Method according to claim 1, wherein the step of assigning (S04) the amount of tokens comprises adding in the blockchain a block comprising a smart contract registering the transfer of the amount of tokens from a vehicle producer's wallet of a producer of the vehicle (10) to the one or more target wallets (30, 40).

3. Method according to claim 2, wherein the transfer of the amount of tokens comprises one of the following: the transfer of the amount of tokens entirely to the driver's wallet (30); the transfer of the amount of tokens entirely to the fleet owner's wallet (40); the transfer of the amount of tokens partially to the driver's wallet (30) and partially to the fleet owner's wallet (40).

4. Method according to claim 1, wherein the step of acquiring (S01) the driving data comprises acquiring (S01) the driving data from sensor means (16) of the vehicle (10).

5. Method according to claim 1, wherein the driving score is inversely proportional to the degree of fuel consumption of the vehicle (10).

6. Method according to claim 1, wherein the step of associating (S03) the token number to the driving score comprises using a look-up table associating to each driving score a respective token number or associating to each range of driving scores a respective range of token numbers.

7. Method according to claim 2, further comprising the step of transferring, through the blockchain, a predetermined token quantity from one of the one or more target wallets (30, 40) to the vehicle producer's wallet in exchange for providing, by the producer of the vehicle (10), a reward to the driver and/or to the vehicle fleet owner.

8. Method according to claim 7, wherein the reward is at least one of the following: one or more gadgets; a discount on the purchase of one or more further vehicles; a discount on one or more services related to the vehicle (10); one or more additional services related to the vehicle (10).

9. Method according to claim 2, wherein the blockchain is owned by the producer of the vehicle (10).

10. Vehicle (10) operable by a driver and comprising a control unit (12) configured to:
acquire driving data indicative of the functioning of the vehicle (10);
determine, based on the driving data, a driving score indicative of a degree of fuel consumption for operating the vehicle (10) by the driver;
associate to the driving score a respective token number indicative of an amount of tokens that depends on said degree of fuel consumption of the vehicle (10); and
assign, through blockchain, the amount of tokens to one or more target wallets (30, 40), the one or more target wallets (30, 40) being a driver's wallet (30) of the driver and/or a fleet owner's wallet (40) of a vehicle fleet owner owning the vehicle (10).

11. Vehicle according to claim 10, the vehicle (10) being a work vehicle or a heavy vehicle.

12. System (70) for the reduction of fuel consumption of at least one vehicle (10) operable by at least one driver,
the system (70) comprising, operatively coupled to each other:
the at least one vehicle (10);
processing means (12, 20); and
one or more target wallets (30, 40), the one or more target wallets (30, 40) being a respective driver's wallet (30) of the at least one driver and/or a fleet owner's wallet (40) of a vehicle fleet owner owning the at least one vehicle (10),
the processing means (12, 20) being configured to:
acquire driving data indicative of the functioning of the at least one vehicle (10);
determine, based on the driving data, at least one driving score indicative of a respective degree of fuel consumption for operating the at least one vehicle (10) by the at least one driver;
associate to the at least one driving score a respective token number indicative of a respective amount of tokens that depends on said degree of fuel consumption of the at least one vehicle (10); and
assign, through blockchain, the at least one amount of tokens to the one or more target wallets (30, 40).

13. System according to claim 12, wherein the processing means (12, 20) comprise a control station (20) configured to implement said blockchain.

14. System according to claim 12, comprising a first plurality of said vehicles (10) operable by a second plurality of said drivers, the vehicles (10) forming a vehicle fleet,
the processing means (12, 20) being configured to:
acquire said driving data from each vehicle (10);
determine, for each vehicle (10) and based on the respective driving data, the respective driving score indicative of the respective degree of fuel consumption for operating said vehicle (10) by the respective driver;
associate to each driving score the respective token number; and
assign, through blockchain, each amount of tokens to the respective one or more target wallets (30, 40).

15. Computer program product storable in processing means (12, 20),
the computer program being designed so that, when executed, the processing means (12, 20) become configured to implement a method (50) for reduction of fuel consumption of a vehicle (10), according to claim 1.
